(19) United States
(12) Patent Application Publication
(10) Pub. No.: US 2003/0121338 A1
(43) Pub. Date: Jul. 3, 2003

(54) Pipeline pigging device for the non-destructive inspection of the fluid environment in a pipeline

(76) Inventor: Anthony Yates, Aberdeen (GB)

Correspondence Address: Arnold & Associates, Suite 630, 2401 Fountainview, Houston, TX, 77057, US

(21) Appl. No.: 10/204,981

(22) PCT Filed: Mar. 14, 2001
(86) PCT No.: PCT/GB01/01130

(30) Foreign Application Priority Data
Mar. 22, 2000 (GB) 0006758.7

(51) Int. Cl. G01N 11/00; G01M 19/00

(52) U.S. Cl. 73/865.8; 73/53.01

(57) ABSTRACT

Apparatus for the monitoring of the fluid environment in a pipeline (14) is described comprising a pigging vehicle (1), within which are contained sensing means (5, 6 and 7) and a data logging device (3). The dimensions of the pigging vehicle (1) are such that its movement is not forced in a conventional manner along the pipeline (14), but instead the pigging vehicle (1) simply travels along under the influence of the production fluid (100). The pigging vehicle (1) further comprises a weight changing mechanism (9) that moves between a first and second condition. After a predetermined time, or after travelling a predetermined distance, the weight changing mechanism (9) may be activated so as to adjust the floatability of the device. By employing this monitoring apparatus advanced warnings of areas of a pipeline that are vulnerable to corrosion can be detected along with areas which have already degraded due to corrosion.

The present invention relates to a pigging vehicle adapted to carry inspection components for monitoring conditions within a pipeline.

It is known in the art that the presence of corrosion in a pipeline is a common problem that can lead to leaks. In the presence of water and oxygen, the process of corrosion acts to deteriorate the integrity of the pipeline.

Sagging and damaged areas of pipeline such as dents, scratches, gouges and pitting are vulnerable to corrosion as they tend to gather water. Due to its higher density, the water lies in contact with the bottom surface of the pipe and the lighter oil layer flows above. Therefore, areas of pipe submersed beneath water are particularly prone to damage by corrosion.

In light of this problem, pipeline conditioned monitoring apparatus is employed to identify the areas of corrosion. British Patent No. GB 2,305,989 teaches of a pipeline pig that carries inspection components including probes and sensors to determine flaws in a pipeline wall that have arisen from corrosion and data storage means to record a continuous condition profile. However, a cleaning pig may fail to sufficiently clean a pipeline at all points and thus the intelligent pigging operation may obtain inaccurate results.

Furthermore, in the past pipeline condition monitoring apparatus has generally been adapted to identify corrosion only after corrosion has occurred. To address this disadvantage of known pigging inspection apparatus, our earlier British Patent Application teaches that it would be preferable to analyse the conditions of the fluid environment in the pipeline (rather than the pipe itself) on the basis that such conditions may provide an indication of the likelihood of future corrosion. However, this too has caused certain difficulties in the past in view of the general construction of pigging devices. Specifically, pigs are provided with flanges such as cups or disks that have an outer diameter substantially corresponding to the inner diameter of the pipeline. In this way, pigs are adapted to be propelled along a pipeline by the change in fluid pressure across these disks or cups. Yet, when it is intended to analyse the fluid environment of a pipeline, this means of propelling the pig tends to substantially alter the fluid environment in the pipeline, thereby rendering any analysis of the fluid environment in the vicinity of the pig somewhat problematic.

In the present invention it is recognised that it would be advantageous to provide a pipeline pigging device for monitoring the prevalent fluid conditions within a pipeline which is both accurate and reliable.

An object of the present invention is to provide a pigging vehicle suitable for analysis of pipeline fluid conditions which minimises any disturbance to the fluid environment from its own presence.

According to the present invention there is provided apparatus for the monitoring of the fluid environment in a pipeline, the apparatus being provided as a pigging vehicle supporting or associated with one or more sensing means for sensing characteristics of the fluid environment, wherein the apparatus further supports or is associated with data logging equipment formed and arranged for receiving and storing data from the sensing means, characterised in that the largest cross sectional dimension of the apparatus is substantially less than the internal diameter of the pipeline.

Typically, the apparatus comprises a spherical body and the sensing means and data logging equipment are provided in the body. Preferably, the outer diameter of the body of the pigging apparatus is not greater than two thirds of the internal diameter of the pipeline.

It would be desirable if the apparatus further included biasing means for encouraging the apparatus to adopt a generally constant up and down orientation, that is the apparatus may include biasing means for mitigating the tendency of the apparatus to roll.

In a preferable embodiment the biasing means would include means for ensuring that the centre of mass of the apparatus was offset from the centre of the sphere such that, in use, the location of the centre of mass remained below the centre of the apparatus.

Preferably, the sensor means are positioned on or near the surface of the apparatus and where the sensor means is designed to detect the presence of water, these sensors may be suitably positioned towards the lower side or surface of the apparatus.

Typically, said sensing means will include conductivity sensors, and may further include temperature sensors, pressure sensors and any other sensors or instruments used in the art to measure or monitor conditions within a pipeline.

Additionally, the apparatus may include instrumentation as will be known in the art as pigging devices. For example, the apparatus may include a tri-axial accelerometer to give information about the orientation of the apparatus in the pipeline at any point in time.

The body may incorporate a protective housing for housing the data logging equipment and instrumentation. Typically, the sensor means would be provided in the apparatus on the outside of the protection housing near to the surface of the apparatus.

Preferably, the overall specific gravity of the apparatus is greater than that of the production fluid and less than the specific gravity of water. Typically, the specific gravity of the apparatus may be approximately 0.85. This has the advantage of allowing apparatus to be partially submerged in any aqueous liquid that may exist within the pipeline as the apparatus flows along the pipeline with the production fluid. Put another way, the apparatus is weighted so as move along the floor of the pipeline in areas where water would collect.

Preferably, the apparatus incorporates weight changing means for altering its specific weight when reaching a predetermined point in the pipeline or after a predetermined period of time has lapsed in order to change its depth.

This feature has two advantages. Firstly, when the pigging device reaches the end of a pipeline its working specific weight is such that it may be difficult to cause the apparatus to float up a riser. As the apparatus is not sized to seal against the internal diameter of the riser it is similarly potentially difficult to pump the apparatus up to surface. However, by altering the specific weight of the apparatus so as to render it lighter than the fluid in the riser, the apparatus is easily retrieved because of its tendency to float. Secondly, in the event that the apparatus was to block or become obstructed at any point in the pipeline, altering its specific weight may cause it to float higher in the pipe and thus overcome an obstacle that may exist, on the bottom of the pipeline.

The weight changing means may comprise of a cavity that in one condition is adapted to fill with production fluid or the like and it a second and weight changed condition is adapted to contained an expanded gas, wherein the gas is adapted to drive a piston or the like which serves to expel the production fluid when activated. The weight changing means may further incorporate a timing device, whereby means for preventing activation of the piston are removed after a predetermined period of time and wherein the piston is encouraged to activate by a mechanical spring of compressed gas.

Preferably, the body is made of a polymer material such as polyurethane.

In order to provide a better understanding of the present invention, example embodiments will now be described with reference to the accompanying figures, in which:

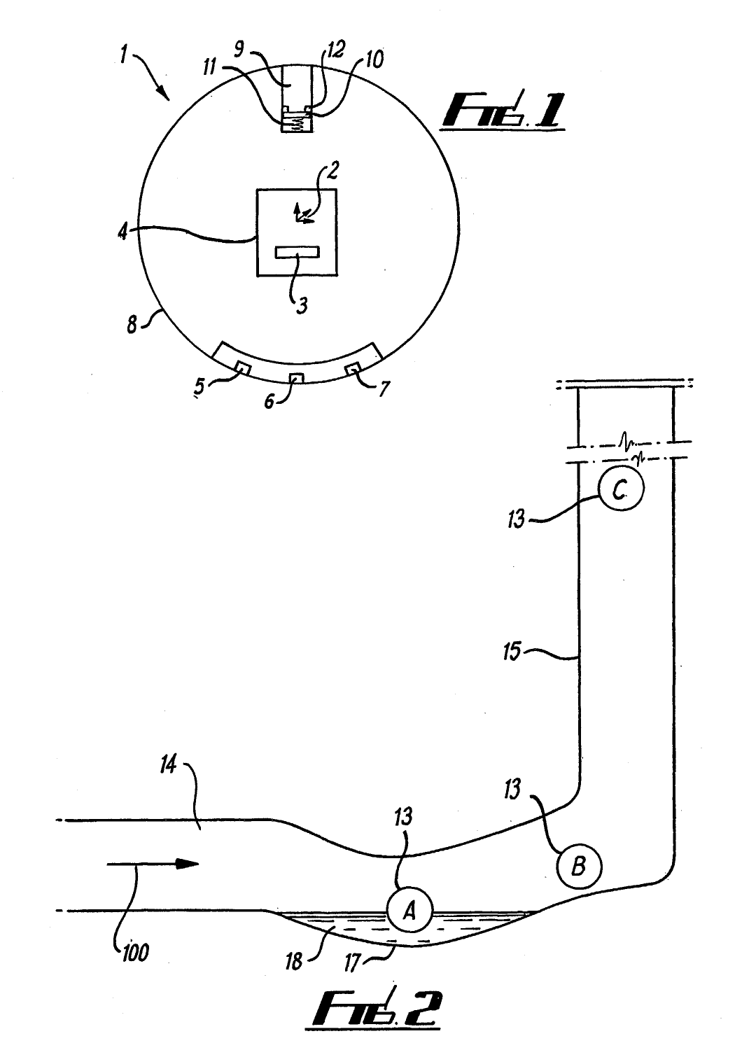

FIG. 1 illustrates apparatus for monitoring the fluid environment within a pipeline in accordance with the present invention; and

FIG. 2 illustrates the use of the present invention in a pipeline.

Referring to FIG. 1, a pigging vehicle is generally depicted at 1 and comprises instruments in the form of a tri-axial accelerometer 2 and data logging means 3. The instruments are contained within a metallic housing 4.

The pigging vehicle 1 is further provided with sensor means including a corrosivity sensor 5, temperature sensor 6 and a well detector 7.

Also, within the body 8 of the apparatus 1 is a weight changing mechanism 9. The weight changing mechanism 9 comprises a cylindrical bore having one end exposed to production fluid (not shown) in use in a pipeline. The opening at the end of the cylindrical bore enables production fluid in a pipeline to enter into the cylindrical bore of the weight changing mechanism 9. In addition, the mechanism 9 incorporates a piston, slidable within the cylindrical bore, and a mechanical spring 11 held typically in compression by a time release valve 12. The time release valve 12 holds the piston 10 for a predetermined period of time after which the valve 12 opens allowing extension of the spring 11 and movement of the piston 10. The activation of the piston 10 serves to expel fluid contained within the cylindrical bore out of the outlet 13. The cavity on the underside of the piston 10 is filled with a lighter fluid, such as a gas or air, than the production fluid, such that the activation of the piston 10 serves to alter the specific weight of the apparatus as a whole.

In the example embodiment FIG. 1, the body 8 is depicted as a sphere. It is envisaged that this would be an appropriate shape of a pigging vehicle in accordance with the present invention, but it is also recognised that the apparatus may take alternative forms and indeed adopt an unlimited number of shapes or profiles. Nevertheless, what is essential to the present invention is that the maximum cross sectional dimension of the apparatus is sufficiently less than the internal diameter of the pipeline in which the apparatus is to be employed. This results in mitigation of the influence of the vehicle's presence, on the fluid environment in the pipeline, as the vehicle or apparatus travels through the pipeline.

The sensor means 5, 6 and 7 are adapted to measure and/or monitor the conditions of the fluid environment and/or the pipeline as the vehicle travels along the pipeline. Information detected by the sensor means is then passed to a data logging device 3 where the information may be processed, either in real time or subsequently upon retrieval of the vehicle from the pipeline.

Turning now to FIG. 2, a pigging vehicle 13 is shown in three positions A, B and C in a pipeline 14. Importantly, it may be noted that the pigging vehicle 13 is of substantially lower diameter than the internal diameter of the pipeline 14.

In use, before placing the pig vehicle 13 in the pipeline 14, one might calculate either the time that the pig is likely to take to travel the length of the pipeline, or the distance that the pig is expected to travel during its journey along the pipeline. A weight change mechanism in the pig 13 is then set to enable a specific weight change to occur when appropriate, such as when the pig 13 reaches the riser 15 in the pipeline 14.

However, prior to the activation of the weight change mechanism, the pigging vehicle 13 is adapted to move along the pipeline 14 in the direction of the flowing production fluid, i.e. oil 100. During this travel, the pig 13 simply travels along with the current or flow of the production fluid and under the influence thereof. Unlike conventional pigging vehicles the extremities of the pigging vehicle are not sized to correspond with the internal diameter dimensions of the pipeline and thus the pigging vehicle is not, as it were, forced in a conventional manner along the pipeline by sealingly engaging the pipeline wall. During its travel the pigging vehicle 13 may reach, for example, a sagged area of pipe 17 caused by a collapsed sand support where there is an area of water 18 along the bottom of the sagged pipe 17. The conductivity sensors in the pig 13 identify the presence of the water 18 in the pipe 14 and this information may then be logged and related to distance or time traveled.

It will be appreciated that the condition of a pipe will change over time and that a pipeline condition profile obtained for a given length of pipeline will exhibit a different profile from a profile taken some time earlier or later. Therefore, by comparing the two profiles for a given pipe obtained at separate times, it is possible to highlight changes in pipeline conditions and consequently give advance warnings of areas of pipe that are vulnerable to corrosion as well as identifying areas already degraded by corrosion.

Thus, it may be seen that a significant advantage of the present invention is that a pigging vehicle may be used to monitor the fluid environment within a pipeline without destroying that fluid environment. A further advantage of an embodiment of the present invention is that the vehicle may be provided with means for altering the specific weight of the vehicle so as to adjust the floatability of the device through the pipeline.

Yet further, a pigging vehicle in accordance with the present invention may be adapted to flow with the production fluid through a pipeline taking a path of least resistance. While the vehicle may incorporate means for maintaining a reasonably constant up/down orientation, the vehicle may nevertheless be free to rotate about a vertical axis and to travel in directions acute to the longitudinal axis of the pipeline. This design adapted for the semi-control of the orientation and attitude of the vehicle allows for mitigating the likelihood of the vehicle being obstructed or stuck at an obstacle in the pipeline, while still enabling meaningful monitoring and data collection by instrumentation and sensors provided in the vehicle.

Further modifications and improvements may be incorporated without departing from the scope of the invention herein intended.

1. Apparatus for the monitoring of the fluid environment in a pipeline, the apparatus being provided as a pigging vehicle supporting or associated with one or more sensing means for sensing characteristics of the fluid environment, wherein the apparatus further supports or is associated with data logging equipment formed and arranged for receiving and storing data from the sensing means, characterised in that the largest cross sectional dimension of the apparatus is substantially less than the internal diameter of the pipeline.

2. Apparatus for the monitoring of the fluid environment in a pipeline as claimed in claim 1, wherein the apparatus comprises a spherical body and the sensing means and data logging equipment are provided in the body.

3. Apparatus for the monitoring of the fluid environment in a pipeline as claimed in claim 1 and claim 2, wherein the outer diameter of the body of the pigging apparatus is not greater than two thirds of the internal diameter of the pipeline.

4. Apparatus for the monitoring of the fluid environment in a pipeline as claimed in any of the preceding claims, wherein the apparatus comprises biasing means for encouraging the apparatus to adopt a generally constant up and down orientation, thereby mitigating the tendency of the apparatus to roll.

5. Apparatus for the monitoring of the fluid environment in a pipeline as claimed in claim 4, wherein the biasing means comprises means for ensuring that the centre of mass of the apparatus is offset from the centre of the sphere such that, in use, the location of the centre of mass remains below the centre of the apparatus.

6. Apparatus for the monitoring of the fluid environment in a pipeline as claimed in any of the preceding claims, wherein the sensor means are positioned on or near surface of the apparatus.

7. Apparatus for the monitoring of the fluid environment in a pipeline as claimed in any of the preceding claims, wherein the sensor means designed to detect the presence of water is positioned towards the lower side or surface of the apparatus.

8. Apparatus for the monitoring of the fluid environment in a pipeline as claimed in any of the preceding claims, wherein the sensing means comprises conductivity sensors, temperature sensors, pressure sensors and any other sensors or instruments used in the art to measure or monitor conditions within a pipeline.

9. Apparatus for the monitoring of the fluid environment in a pipeline as claimed in any of the preceding claims, wherein the apparatus comprises a tri-axial accelerometer to give information about the orientation of the apparatus in the pipeline at any point in time.

10. Apparatus for the monitoring of the fluid environment in a pipeline as claimed in any of the preceding claims, wherein the body incorporates a protective housing for housing the data logging equipment and instrumentation.

11. Apparatus for the monitoring of the fluid environment in a pipeline as claimed in any of the preceding claims, wherein the sensor means are provided in the apparatus on the outside of the protection housing near to the surface of the apparatus.

12. Apparatus for the monitoring of the fluid environment in a pipeline as claimed in any of the preceding claims, wherein the overall specific gravity of the apparatus is greater than that of the production fluid and less than the specific gravity of water.

13. Apparatus for the monitoring of the fluid environment in a pipeline as claimed in any of the preceding claims, wherein the apparatus incorporates weight changing means for altering its specific weight when reaching a predetermined point in the pipeline, or after a predetermined period of time has lapsed, in order to change its depth.

14. Apparatus for the monitoring of the fluid environment in a pipeline as claimed in claim 13, wherein the weight changing means comprises a cavity that in a first condition is adapted to fill with production fluid or the like, and in a second weight changed condition is adapted to contain an expanded gas, wherein the gas is adapted to drive a piston or the like which serves to expel the production fluid when activated.

15. Apparatus for the monitoring of the fluid environment in a pipeline as claimed in claim 13 and claim 14, wherein the weight changing means comprises a timing device, whereby means for preventing activation of the piston are removed after a predetermined period of time and wherein the piston is encouraged to activate by a mechanical spring of compressed gas.

16. Apparatus for the monitoring of the fluid environment in a pipeline as claimed in any of the preceding claims, wherein the body is made of a polymer material such as polyurethane.
